(19) United States
(12) Patent Application Publication
(10) Pub. No.: US 2024/0198508 A1
(43) Pub. Date: Jun. 20, 2024

(54) SIDE HANDLE FOR A POWER TOOL

(71) Applicant: MILWAUKEE ELECTRIC TOOL CORPORATION, Brookfield, WI (US)

(72) Inventors: Nicholas J. Losch, Hales Corners, WI (US); Ian Allen Duncan, Colgate, WI (US)

(21) Appl. No.: 18/539,679

(22) Filed: Dec. 14, 2023

Related U.S. Application Data
(60) Provisional application No. 63/387,843, filed on Dec. 16, 2022.

(51) Int. Cl. B25F 5/02

(52) U.S. Cl. CPC B25F 5/025

(57) ABSTRACT

A side handle assembly for securing to a neck of a power tool includes a handle configured to be gripped by a user, a rod including a first end to which the handle is coupled and an opposite, second end, a first clamp coupled to the second end of the rod, and a second clamp positioned opposite the first clamp. The neck of the power tool is receivable between the first clamp and the second clamp, with a clamping force applied to the neck, when the first and second clamps are maintained in a clamped state. The side handle further includes a cam lever configured to adjust the first and second clamps between the clamped state and a released state, where the clamping force is removed from the power tool neck.

### CROSS-REFERENCE TO RELATED APPLICATIONS

This application claims priority to co-pending U.S. Provisional Patent Application No. 63/387,843, filed on Dec. 16, 2022, the entire contents of which is incorporated herein by reference.

### FIELD OF THE INVENTION

The present invention relates to power tools, and more particularly, to side handle assemblies for use with power tools.

### BACKGROUND OF THE INVENTION

Various power tools that use tool bits are known in the art. The power tools can be used for cutting workpieces and/or driving fasteners (e.g., bolts, screws, etc.) into the work pieces using the tool bits. In some instances, a power tool can be positioned relative to the workpiece for performing the cutting and/or driving. However, the power tool position relative to the workpiece may be undesirable for performing the cutting and/or driving. Undesirable positioning of the power tool relative to the workpiece results in less stabilization of the power tool thereby providing unsatisfactory results to the workpiece. A power tool that is not stabilized relative to the workpiece may provide undesirable interaction with the workpiece.

### SUMMARY OF THE INVENTION

The present invention provides, in one aspect, a side handle assembly for securing to a neck of a power tool includes a handle configured to be gripped by a user, a rod including a first end to which the handle is coupled and an opposite, second end, a first clamp coupled to the second end of the rod, and a second clamp positioned opposite the first clamp. The neck of the power tool is receivable between the first clamp and the second clamp, with a clamping force applied to the neck, when the first and second clamps are maintained in a clamped state. The side handle further includes a cam lever configured to adjust the first and second clamps between the clamped state and a released state, where the clamping force is removed from the power tool neck.

The present invention provides, in another aspect, a side handle assembly for securing to a neck of a power tool. The side handle includes a handle configured to be gripped by a user, a rod including a first end to which the handle is coupled and an opposite, second end, a first clamp coupled to the second end of the rod, a second clamp positioned opposite the first clamp. The neck of the power tool being receivable between the first clamp and the second clamp, with a clamping force applied to the neck, when the first and second clamps are maintained in a clamped state. The side handle includes a cam lever configured to adjust the first and second clamps between the clamped state and a released state, where the clamping force is removed from the power tool neck. The side handle further includes an orientation adjustment mechanism coupling the second end of the rod to the first clamp. The orientation adjustment mechanism is configured to adjust an orientation of the rod and the handle with respect to at least one of the first clamp or the second clamp.

Other features and aspects of the invention will become apparent by consideration of the following detailed description and accompanying drawings.

### BRIEF DESCRIPTION OF THE DRAWINGS

FIG. 1 is a perspective view of a power tool.

FIG. 2 is a perspective view of a side handle assembly according to an embodiment of the invention, for use with the power tool of FIG. 1.

FIG. 3 is a top view of the side handle assembly of FIG. 2.

FIG. 4 is a cross-sectional view of the side handle assembly of FIG. 2 through section 4-4 in FIG. 2.

FIG. 5 is a front view of a mounting assembly of the side handle assembly of FIG. 2, with a handle removed.

FIG. 6 is a cross-sectional view of the mounting assembly of FIG. 5 through section 6-6 in FIG. 3.

FIG. 7 is a side handle assembly according to an embodiment of the invention, for use with the power tool of FIG. 1.

FIG. 8 is a cross-sectional view of the side handle assembly of FIG. 7 attached to the power tool of FIG. 1.

FIG. 9 is a front view of the side handle assembly of FIG. 7.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

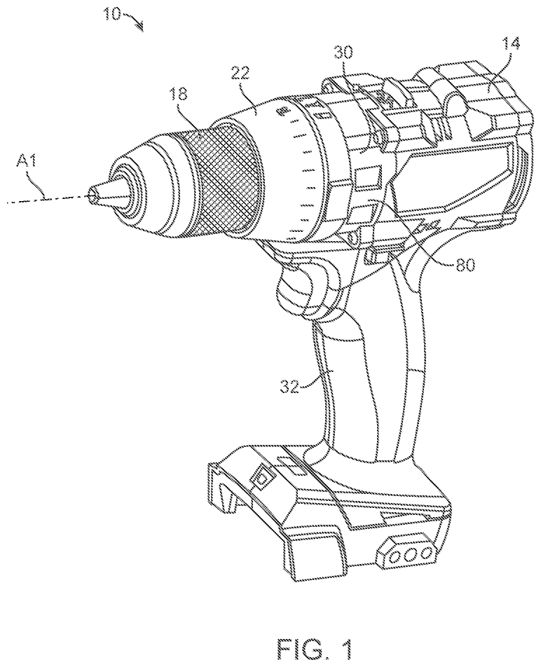

FIG. 1 illustrates a rotary power tool 10 (e.g., a drill or hammer drill). The power tool 10 includes a housing 14, a chuck 18, and a clutch ring 22. A tool bit (not shown) can be secured to the chuck 18 for co-rotation with the chuck 18 about a rotational axis A1. The tool bit is configured to perform work on a workpiece.

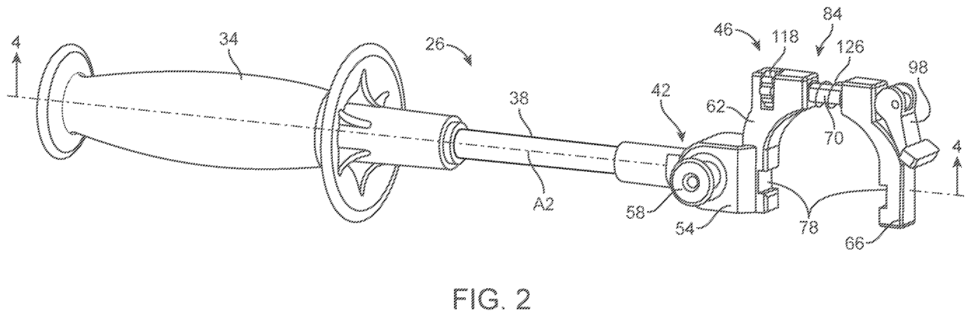

FIG. 2 illustrates a side handle assembly 26 (hereafter “the side handle 26”) according to an embodiment of the invention. The side handle 26 allows a user to grasp the power tool 10 at two different locations, rather than one location, to better stabilize the power tool 10 relative to the workpiece. The side handle 26 is mounted to a neck or gear case 30 of the power tool 10, which is coaxial with the rotational axis A1 (FIG. 1). The side handle 26 allows the operator to grasp the power tool 10 at two distinct locations such as the main handle 32 of the power tool 10 and the side handle 26, proximate the chuck 18.

With reference to FIG. 2, the side handle 26 includes a handle 34 that is configured to be gripped by the user, and a rod 38 attached to the handle 34. The rod 38 is fixedly attached to the handle 28 such that rotation of the handle 34 results in a similar rotation of the rod 38 about a common longitudinal axis A2. In other words, the rod 38 is rotational fixed relative to the handle 34. In the illustrated embodiment, the handle 34 is attached to a first end of the rod 38.

With continued reference to FIG. 2, the side handle 26 also includes an orientation adjustment mechanism 42 and a mounting assembly 46. The orientation adjustment mechanism 42 and the mounting assembly 46 are coupled to a second end of the rod 38 opposite the first end. The orientation adjustment mechanism 42 permits adjustment of the orientation of the side handle 26 with respect to the power tool 10 without removal of the mounting assembly 46 from the power tool 10. The mounting assembly 46 can be mounted to the neck or gear case 30 of the power tool 10 to clamp the side handle 26 to the power tool 10.

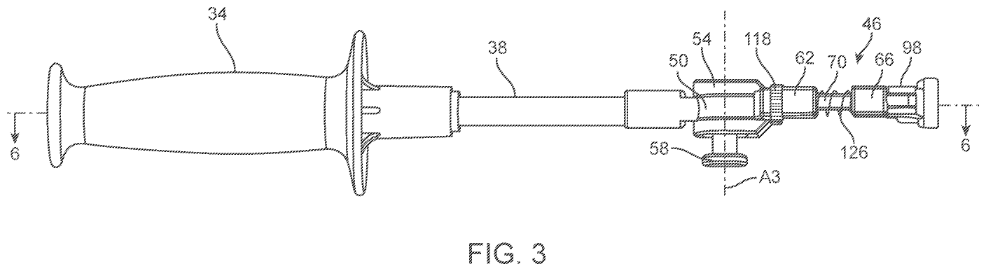

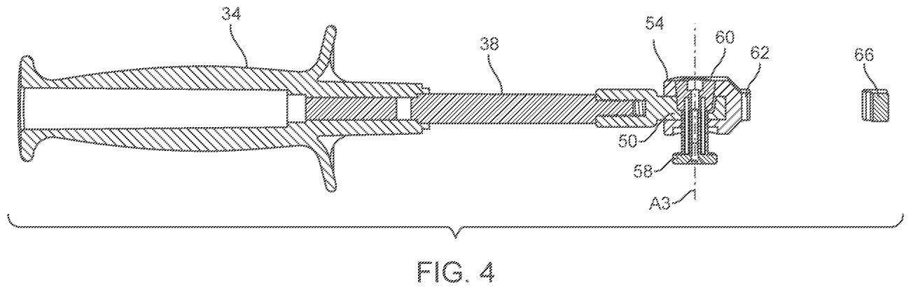

FIGS. 3 and 4 illustrate the orientation adjustment mechanism 42 including a mated pair of face gears 50, 54, each having radially extending teeth arranged about an adjustment axis or rotational axis A3 of the respective face gear 50, 54. The face gear 54 may have radially extending teeth arranged on an insert 60 (FIG. 4). The insert 60 may be integrally formed with the face gear 54 or may be formed separately and coupled to the face gear 54. The rotational axis A3 may be oriented transverse to a longitudinal axis of the handle 34 and the rod 38. A first face gear 50 is affixed to the second end of the rod 38 and a second face gear 54 is affixed to the mounting assembly 46. With continued reference to FIGS. 3 and 4, a fastener 58 secures the first face gear 50 to the second face gear 54. When the fastener 58 is tightened, the first face gear 50 mates or engages with the second face gear 54, thereby preventing relative rotation between the first face gear 50 and the second face gear 54. In other words, tightening the fastener 58 fixes the orientation of the handle 34 and rod 38 with respect to the mounting assembly 46 by fixing the orientation of the first and second face gears 50, 54. When the fastener 58 is loosened, the first face gear 50 can disengage the second face gear 54, thereby allowing relative rotation between the first face gear 50 and the second face gear 54. The relative rotation allows for the orientation of the side handle 26 to be adjusted with respect to the power tool 10 without removing the mounting assembly 46 from the power tool 10.

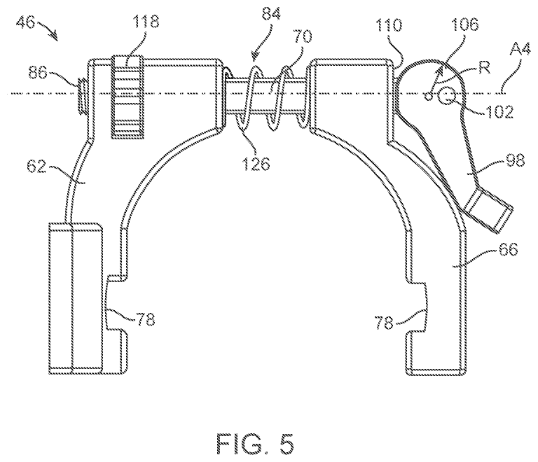

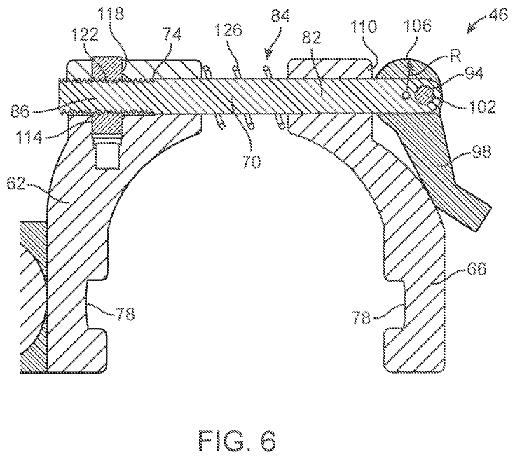

With reference to FIGS. 5 and 6, the mounting assembly 46 includes a first clamp 62, a second clamp 66, and a link 70. The first clamp 62 is coupled to the second end of the rod 38. In other embodiments, the second clamp 66 can be coupled to the second end of the rod 38. The first clamp 62 can be shaped to correspond with a portion of the neck or gear case 30 of the power tool 10. The first clamp 62 is configured to grip the power tool 10 when the mounting assembly 46 is installed onto the power tool 10. The first clamp 62 includes a first through bore 74 configured to receive the link 70. In the illustrated embodiment, the first clamp 62 includes a detent 78 configured to engage with a corresponding protrusion 80 on the neck or gear case 30 of the power tool 10. The detent 78 allows the first clamp 62 to interlock with the power tool neck or gear case 30 to clamp the mounting assembly 46 to the power tool 10. In the illustrated embodiment, the first clamp 62 is integrally formed with the second face gear 54 as a single piece. In other embodiments, the first clamp 62 can be separately formed from the second face gear 54 and attached thereto with a secondary manufacturing process (e.g., welding) or a fastener.

With continued reference to FIGS. 5 and 6, the second clamp 66 can shaped to correspond with a portion of the neck 30 of the power tool 10. The second clamp 66 is configured to grip the power tool 10 when the mounting assembly 46 is installed onto the power tool 10. The second clamp 66 can include a second through bore 82 configured to receive the link 70. Similar to the first clamp 62, the second clamp 66 can comprise one or more detents 78 configured to couple with one or more protrusions 80 on the power tool neck 30.

With reference to FIG. 6, the link 70 includes a first, threaded portion or end 86 and an opposite, unthreaded second end 94. The link 70 is inserted within the first through bore 74 of the first clamp 62 and the second through bore 82 of the second clamp 66. Further, the threaded end 86 of the link 70 is inserted within the first through bore 74 of the first clamp 62.

FIGS. 5 and 6 illustrate a clamping mechanism 84 configured to adjust the first and second clamps 62, 66 between a clamped state and a released state. In some embodiments, the clamp mechanism 84 includes the link 70 and a cam lever 98 attached to the link 70. The cam lever 98 is attached to the second end 94 (i.e., pulling end 94) of the link 70. The cam lever 98 is pivotably coupled to the link 70 via a pin 102. The pin 102 extends through the cam lever 98 and the link 70. The cam lever 98 is configured to pivot about the pin 102 between a locked position and an unlocked position.

With continued reference to FIGS. 5 and 6, the cam lever 98 is in sliding contact with the second clamp 66 which, in turn, is stationary in relation to the cam lever 98. The cam lever 98 includes a cam lever surface 106 configured to engage a second clamp surface 110 of the second clamp 66. In one embodiment, the cam lever surface 106 defines a progressively changing radius of contact R, and the second clamp surface 110 defines a flat surface. As the cam lever 98 pivots about the pin 102, the cam lever surface 106 imparts translation of the second clamp 66 (thus causing a compression spring 126 to compress) along the longitudinal axis A4 as the cam lever 98 is rotated in a direction coinciding with an increasing radius of contact R. Similarly, as the cam lever 98 is rotated in an opposite direction coinciding with a decreasing radius of contact R, the compression spring 126 rebounds, pushing the second clamp 66 in an opposite direction. As discussed in more detail below, engagement of the cam lever surface 106 and the second clamp surface 110 adjusts the clamping mechanism 84 from the released state to the clamped state, thereby clamping the mounting assembly 46 to the neck or gear case 30 of the power tool 10.

In some embodiments, the clamping mechanism 84 further includes an adjustment nut 118. The second clamp 66 further defines a recess 114 in which the adjustment nut 118 is received (FIG. 6). The adjustment nut 118 includes a threaded bore 122 in which the threaded end 86 of the link 70 is received. In response to rotation of the nut 118 within the recess 114 and relative to the link 70, the adjustment nut 118 is configured to adjust a distance between the second clamp 66 and the first clamp 62 along a longitudinal axis A4 (FIG. 5).

In operation, as the adjustment nut 118 is rotated in a first rotational direction (e.g., clockwise), the first and second clamps 62, 66 are moved toward each other due to the interaction of the threaded end 86 of the link 70 and the threaded bore 122 of the adjustment nut 118. The resulting distance decrease between the first clamp 62 and the second clamp 66 allows the clamps 62, 66 to accommodate various power tool neck 30 sizes or widths. Rotation of the adjustment nut 118 in a second rotational direction (e.g., counterclockwise) opposite the first rotational direction, separates the first and second clamps 62, 66 away from each other.

With reference to FIG. 5, in the illustrated embodiment, the mounting assembly 46 includes a compression spring 126 located around the link 70 and between the first clamp 62 and the second clamp 66. As such, the compression spring 126 biases the clamps 62, 66 away from each other when in the released state. In some embodiments, the compression spring 126 is maintained in a preloaded (i.e., compressed) state when the clamps 62, 66 are in the released state. As such, the compression spring 126 is further compressed when the first and second clamps 62, 66 are adjusted to the clamped state. In some embodiments of the side handle 26, the compression spring 126 may be omitted, such that the clamps 62, 66 are not biased into the released state.

In operation, the clamping mechanism 84 is adjustable between a released state when not mounted to the power tool 10, and in a clamped state when clamped around the neck or gear case 30 of the power tool 10. The neck 30 of the power tool 10 is receivable between the first clamp 62 and the second clamp 66. The cam lever 98 is away from the second clamp 66 in the released state. The cam lever 98 is adjacent the second clamp 66 in the clamped state (FIGS. 2 and 5). When an operator wants to securely clamp the side handle 26 to the neck 30, the operator pushes the cam lever 98 downward and towards the second clamp 66. As the cam lever 98 pivots about the pin 102, the pulling end 94 of the link 70 is drawn slightly in a direction away from the first clamp 62 (i.e., to the right in FIGS. 2 and 5). As the pulling end 94 is drawn away from the first clamp 62, the cam lever 98 pushes the second clamp 66 towards the first clamp 62 against the biasing force of the compression spring 126. The cam lever 98 pivots about the pin 102 until the cam lever surface 106 sits against the second clamp surface 110 thereby clamping the mounting assembly 46 to the power tool neck 30 in the clamped state. The cam lever 98 is prevented from inadvertently slipping back to the released state due to the engagement between the cam lever surface 106 and the second clamp surface 110, and the biasing force of the compression spring 126.

When the operator wants to unlock the clamping mechanism 84, the operator moves the cam lever 98 upward and away from the second clamp 66 thereby disengaging the cam lever surface 106 from the second clamp surface 110. The pulling end 94 now moves towards the first clamp 62 due to the biasing force of the compression spring 126 pushing the second clamp 66 against the cam lever 98. The cam lever 98 pivots to a position where the cam lever surface 106 and the second clamp surface 110 disengage from each other thereby unlocking the mounting assembly 46. In the released state, the first clamp 62 and the second clamp 66 are separated enough (due to compression spring 126) that the operator can remove the side handle 26 away and/or readjust the side handle 26 with respect to the power tool neck 30.

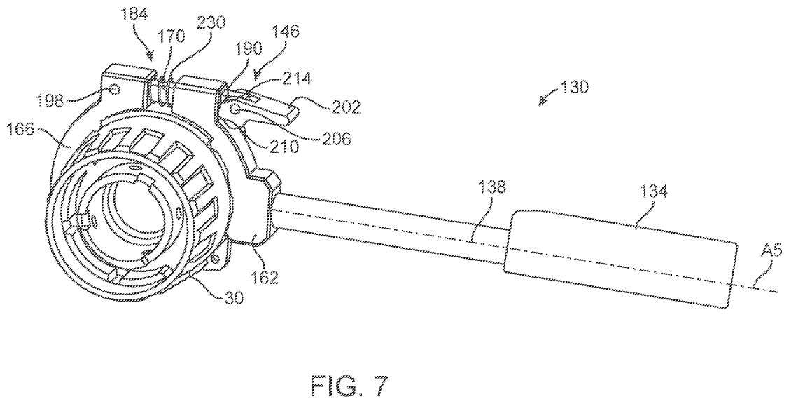

FIG. 7 illustrates a side handle assembly 130 (hereafter “the side handle 130”) according to another embodiment of the invention. Similar to the side handle 26 described above, the side handle 130 is mounted to the neck or gear case 30 of the power tool 10, which is coaxial with the rotational axis A1 (FIG. 1). The side handle 130 allows the operator to grasp the power tool 10 at two distinct locations, rather than one location, to better stabilize the power tool 10 relative to a workpiece.

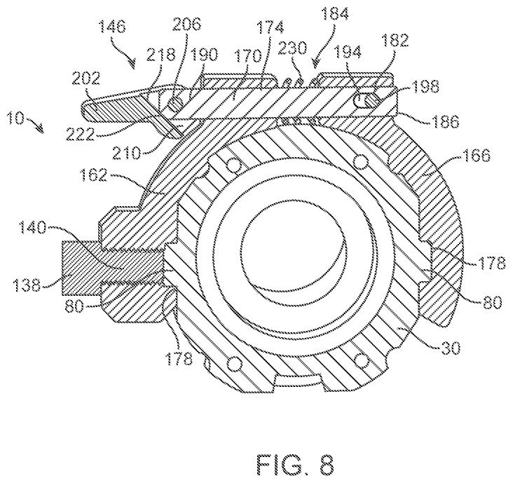

The side handle 130 can include a handle 134 that is configured to be gripped by the user, and a rod 138 attached to the handle 134. The rod 138 is fixedly attached to the handle 134 such that rotation of the handle 134 results in a similar rotation of the rod 138 about a common longitudinal axis A5. In other words, the rod 138 is rotational fixed relative to the handle 134. As illustrated in FIG. 7, the handle 134 can be attached to a first end of the rod 138. In some embodiments, the rod 138 can be coupled to the second clamp 166, e.g., via a threaded end 140 (FIG. 8).

Referring to FIGS. 7 and 8, the side handle 130 can further include an orientation adjustment mechanism (not shown) and a mounting assembly 146. The orientation adjustment mechanism (not shown) and the mounting assembly 146 can be attached to a second end of the rod 138 opposite the first end. The orientation adjustment mechanism can include a mated pair of face gears (not shown) as described above for the side handle 26. The orientation adjustment mechanism permits adjustment of the orientation of the side handle 130 with respect to the power tool 10 without removal of the mounting assembly 146 from the power tool 10. The mounting assembly 146 can be mounted to the neck or gear case 30 of the power tool 10 to clamp the side handle 130 to the power tool 10.

With continued reference to FIGS. 7 and 8, the mounting assembly 146 includes a first clamp 162, a second clamp 166, and a link 170. The first clamp 162 is coupled to the second end of the rod 138. In some embodiments, the first clamp 162 can comprise a threaded bore configured to receive a threaded end 140 of the rod 138 (FIG. 8). In other embodiments, the second clamp 166 can be coupled to the second end of the rod 138. The first clamp 162 can be shaped to correspond with a portion of the neck 30 of the power tool 10. The first clamp 162 is configured to grip the power tool 10 when the mounting assembly 146 is clamped to the power tool 10. The first clamp 162 includes a first through bore 174 configured to receive the link 170. The first clamp 162 includes a detent 178 configured engage with corresponding protrusion 80 on the neck or gear case 30 of the power tool 10. The detent 178 allows the first clamp 162 to interlock with the power tool neck or gear case 30 to clamp the mounting assembly 146 to the power tool 10.

With continued reference to FIGS. 7 and 8, the second clamp 166 can be shaped to correspond with a portion of the neck 30 of the power tool 10. The second clamp 166 is configured to grip the power tool 10 when the mounting assembly 146 is clamped to the power tool 10. The second clamp 166 includes a second through bore 182 configured to receive the link 170. Similar to the first clamp 162, the second clamp 166 includes a detent 178 configured engage with corresponding protrusion 80 on the power tool neck or gear case 30.

With reference to FIG. 8, the link 170 comprises a first end 186 and a second end 190 opposite the first end 186. The link 170 is inserted within the first through bore 174 of the first clamp 162, and the second through bore 182 of the second clamp 166. The link 170 further defines a groove 194 adjacent the first end 186. The link 170 can be secured to the second clamp 166 via a first pin 198. The first pin 198 extends through the second clamp 166 and groove 194 of the link 170.

FIGS. 7 and 8 illustrate a clamping mechanism 184 configured to adjust the first and second clamps 162, 166 between a clamped state and a released state. In some embodiments, the clamping mechanism 184 includes the link 170 and a cam lever 202 attached to the link 170. The cam lever 202 can be attached to the second end 190 (i.e., pulling end 190) of the link 170. The cam lever 202 can be pivotably coupled to the link 170 via a second pin 206. The second pin 206 extends through the cam lever 202 and the link 170. The cam lever 202 can be configured to pivot about the second pin 206 between a locked position and an unlocked position.

With continued reference to FIGS. 7 and 8, the cam lever 202 is in sliding contact with the first clamp 162 which, in turn, is stationary in relation to the cam lever 202. The cam lever 202 includes a flat surface 210 that corresponds to a flat side 214 of the first clamp 162. The cam lever 202 further includes an inclined edge 218 that corresponds to an angled edge 222 of the second end 190 of the link 170. As the cam lever 202 pivots about the second pin 206, the cam lever flat surface 210 imparts translation of the second clamp 166 toward the first clamp 162 (thus causing a compression spring 230 to compress) as the cam lever 202 is rotated about the second pin 206. Similarly, as the cam lever 202 is rotated in an opposite direction, the compression spring 230 rebounds, pushing the second clamp 166 in an opposite direction. As discussed in more detail below, engagement of the cam lever flat surface 210 to the first clamp flat side 214, and the cam lever inclined edge 218 to the link angled edge 222 locks the mounting assembly 146 to the neck or gear case 30 of the power tool 10.

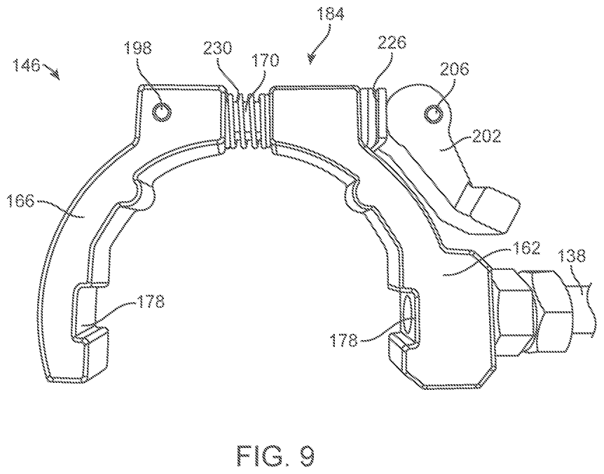

FIG. 9 illustrates the clamping mechanism 184 further comprising one or more damping members 226. The one or more damping members 226 are coupled to the link 170 adjacent to the cam lever 202. The one or more damping members 226 are positioned between the cam lever 202 and the first clamp 162. The one or more damping members 226 can be, but not limited to, an elastic member, an O-ring, a metal plate, or any other suitable member configured to adjust the distance between the clamps 162, 166. The one or more damping members 226 can comprise one, two, three, four, or five damping members 226. The one or more damping members 226 can be configured to adjust the distance between the first and second clamps 162, 166. In other words, the one or more damping members 226 can be configured to allow the clamps 162, 166 to adjust (i.e., give) to provide a sufficient distance between the clamps 162, 166 for clamping around the neck or gear case 30 of the power tool 10. The one or more damping members 226 allows for slight adjustments to the clamps 162, 166 for various power tool neck sizes or variable distance between the clamps 162, 166 due to wear.

As illustrated in FIGS. 7 and 8, the mounting assembly 146 further includes a compression spring 230 located around the link 170 and between the first clamp 162 and the second clamp 166. As such, the compression spring 230 biases the clamps 162, 166 away from each other when in a released state. In some embodiments, the compression spring 230 is maintained in a preloaded (i.e., compressed) state when the clamps 162, 166 are in the released state. As such, the compression spring 230 is further compressed when the first and second clamps 162, 166 are adjusted in a clamped state. In some embodiments of the side handle 130, the compression spring 230 may be omitted, such that the clamps 162, 166 are not biased into the released state.

In operation, the clamping mechanism 184 is originally in the released state, as shown in FIGS. 7 and 8. The neck 30 of the power tool 10 is receivable between the first clamp 162 and the second clamp 166. When an operator wants to securely clamp the side handle 130 to the neck 30, the operator pushes the cam lever 202 towards the first clamp 162. As the cam lever 202 pivots about second pin 206, the angled edge 222 of the pulling end 190 slides against the inclined edge 218 of the cam lever 202 and the pulling end 190 is drawn slightly in a direction away from the second clamp 166 (i.e., to the right in FIG. 7 and to the left in FIG. 8). As the pulling end 190 is drawn away from the second clamp 162, the link 170 pulls the second clamp 166 towards the first clamp 162 via the first pin 198, against the biasing force of the spring 230. The cam lever 202 pivots about the second pin 206 until the flat surface 210 is set against the flat side 214 of the first clamp 162, at which point the cam lever 202 is in the locked position and the mounting assembly 146 has thereby clamped the first and second clamps 162, 166 about the neck 30. The cam lever 202 is prevented from inadvertently slipping back to the unlocked position by virtue of the flat surface 210 being engaged against the flat side 214 and due to the biasing force from compression spring 230.

When an operator wants to unlock the clamping mechanism 184, the operator lifts the cam lever 202 away from the first clamp 162. The pulling end 190 now moves back towards the second clamp 166, due to the biasing force of compression spring 230 pushing the first clamp 162 against the cam lever 202, while the angled edge 222 slides along the inclined edge 218. Once the cam lever 202 has pivoted about the second pin 206 to a position in which the flat surface 210 slides off the flat side 214 of the first clamp 162, the cam lever 202 returns to the released state as shown in FIGS. 7 and 8. In the released state, the first and second clamps 162, 166 are separated enough (due to compression spring 230) that the operator can remove the side handle 130 away and/or readjust the side handle 130 with respect to the power tool neck 30.

Although the invention has been described in detail with reference to certain preferred embodiments, variations and modifications exist within the scope and spirit of one or more independent aspects of the invention as described.

What is claimed is:

1. A side handle assembly for securing to a neck of a power tool, the side handle comprising:
a handle configured to be gripped by a user;
a rod including a first end to which the handle is coupled and an opposite, second end;
a first clamp coupled to the second end of the rod;
a second clamp positioned opposite the first clamp, the neck of the power tool being receivable between the first clamp and the second clamp, with a clamping force applied to the neck, when the first and second clamps are maintained in a clamped state; and
a cam lever configured to adjust the first and second clamps between the clamped state and a released state, where the clamping force is removed from the power tool neck.

2. The side handle assembly of claim 1, wherein the first clamp includes a first through-bore, wherein the second clamp includes a second through-bore, and wherein the side handle assembly further comprises a link having first and second ends, respectively, received in the first and second through-bores.

3. The side handle assembly of claim 2, further comprising an adjustment nut including a threaded bore configured to receive a threaded portion of the link, wherein the threaded portion of the link is disposed within the first through-bore.

4. The side handle assembly of claim 3, wherein, in response to rotation of the adjustment nut relative to the link, a distance between the second clamp and the first clamp is adjusted along a longitudinal axis of the link.

5. The side handle assembly of claim 2, wherein the cam lever is pivotably coupled to the second end of the link with a pin.

6. The side handle assembly of claim 5, wherein the cam lever includes a cam lever surface, wherein the second clamp includes a second clamp surface configured to engage with the cam lever surface, and wherein the engagement of the cam lever surface and the second clamp surface maintains the first clamp and the second clamp in the clamped state.

7. The side handle assembly of claim 5, further comprising a damping member positioned between the cam lever and the second clamp.

8. The side handle assembly of claim 7, wherein the damping member is selected from the group consisting of an elastic member, an O-ring, and a metal plate.

9. The side handle assembly of claim 1, further comprising a spring positioned between the first clamp and the second clamp, wherein the spring is configured to bias the first clamp and the second clamp away from one another toward the released state.

10. A side handle assembly for securing to a neck of a power tool, the side handle comprising:
a handle configured to be gripped by a user;
a rod including a first end to which the handle is coupled and an opposite, second end;
a first clamp coupled to the second end of the rod;
a second clamp positioned opposite the first clamp, the neck of the power tool being receivable between the first clamp and the second clamp, with a clamping force applied to the neck, when the first and second clamps are maintained in a clamped state;
a cam lever configured to adjust the first and second clamps between the clamped state and a released state, where the clamping force is removed from the power tool neck; and
an orientation adjustment mechanism coupling the second end of the rod to the first clamp, wherein the orientation adjustment mechanism is configured to adjust an orientation of the rod and the handle with respect to at least one of the first clamp or the second clamp.

11. The side handle assembly of claim 10, wherein the first clamp includes a first through-bore, wherein the second clamp includes a second through-bore, and wherein the side handle assembly further comprises a link having first and second ends, respectively, received in the first and second through-bores.

12. The side handle assembly of claim 11, further comprising an adjustment nut including a threaded bore configured to receive a threaded portion of the link, wherein the threaded portion of the link is disposed within the first through-bore.

13. The side handle assembly of claim 12, wherein, in response to rotation of the adjustment nut relative to the link, a distance between the second clamp and the first clamp is adjusted along a longitudinal axis of the link.

14. The side handle assembly of claim 11, wherein the cam lever is pivotably coupled to the second end of the link with a pin.

15. The side handle assembly of claim 14, wherein the cam lever includes a cam lever surface, wherein the second clamp includes a second clamp surface configured to engage with the cam lever surface, and wherein the engagement of the cam lever surface and the second clamp surface maintains the first clamp and the second clamp in the clamped state.

16. The side handle assembly of claim 14, further comprising a damping member positioned between the cam lever and the second clamp.

17. The side handle assembly of claim 16, wherein the damping member is selected from the group consisting of an elastic member, an O-ring, and a metal plate.

18. The side handle assembly of claim 10, further comprising a spring positioned between the first clamp and the second clamp, wherein the spring is configured to bias the first clamp and the second clamp away from one another toward the released state.

19. The side handle assembly of claim 10, wherein the orientation adjustment mechanism includes
a first face gear fixedly coupled to the second end of the rod,
a second face gear fixedly coupled to the first clamp, and
a fastener selectively coupling the first face gear to the second face gear such that when the fastener is tightened, the first face gear is engaged with the second face gear to prevent relative rotation between the first face gear and the second face gear, and when the fastener is loosened, the first face gear is disengaged with the second face gear to allow relative rotation between the first face gear and the second face gear.

20. The side handle assembly of claim 19, wherein the first face gear is rotatable relative to the second face gear about an adjustment axis that is oriented transverse to a longitudinal axis of the handle.
